(19) United States
(12) Patent Application Publication
(10) Pub. No.: US 2015/0134386 A1
(43) Pub. Date: May 14, 2015

(54) COLLECTIVELY OPTIMIZING GROUP SCHEDULES TO MINIMIZE PROJECT COMPLETION TIME AND COST

(71) Applicants: PRACHI PRASAD JOGALEKAR, SAN JOSE, CA (US); PRASAD PRABHAKAR JOGALEKAR, SAN JOSE, CA (US); ANUSHKA PRASAD JOGALEKAR, SAN JOSE, CA (US)

(72) Inventors: PRACHI PRASAD JOGALEKAR, SAN JOSE, CA (US); PRASAD PRABHAKAR JOGALEKAR, SAN JOSE, CA (US); ANUSHKA PRASAD JOGALEKAR, SAN JOSE, CA (US)

(21) Appl. No.: 14/276,748

(22) Filed: May 13, 2014

Related U.S. Application Data
(60) Provisional application No. 61/901,518, filed on Nov. 8, 2013.

(51) Int. Cl. G06Q 10/06

(52) U.S. Cl. CPC G06Q 10/063118
USPC 705/7.13

(57) ABSTRACT

A system and method for collectively optimizing group schedules to minimize completion time and project cost is disclosed. The method of some embodiments uses optimization techniques to collectively minimize the time and cost for the whole project, given the tasks, members and their attributes and dependencies. The system includes a project and task data store, a data validation engine, an analytics and correlation engine to resolve task prerequisites and dependencies, an optimizer to identify optimal task schedules according to a set of team members and associated project attributes, and an output generator to format a project calendar with all tasks and member assignments.

### CLAIM OF BENEFIT TO PRIOR APPLICATION

This application claims benefit to U.S. Provisional Patent Application 61/901,518, entitled “A Method For Collectively Optimizing Group Schedules To Minimize Completion Time And Project Cost,” filed Nov. 8, 2013. The U.S. Provisional Patent Application 61/901,518 is incorporated herein by reference.

### BACKGROUND

Embodiments of the invention described in this specification relate generally to scheduling, and more particularly, to organizing group scheduling.

People typically use a calendar to plan future events. For instance, a person adds a calendar entry for a doctor appointment that is scheduled in two weeks. Many people are formally or informally organized in groups whose members need some ability to plan future events in light of the schedules of other members. Typically, this involves communicating via phone, text, or email with each member to determine when everyone in the group has availability to participate in a particular event. However, this is often inefficient since it depends on full communication across the group, which is often not possible instantly or even after some time. This problematic for group members who wish to plan events for the group.

The problem is escalated when there are a set of specific tasks which need to be performed by a set of specific people who may need to perform the tasks in some collective manner. Furthermore, the tasks themselves may include specific constraints that make scheduling a greater challenge. For instance, some tasks require a minimum set of people or resources to engage in the task, which may have a specific time in which the people can perform and complete the task, or may otherwise have certain dependencies (e.g., in relation to other tasks or in relation to the availability of other members who are assigned other tasks, etc.) and/or elevated importance or urgency. The available project management and calendaring tools are simply unable to optimize scheduling across a group of people to provide for the best possible task allocation for the group members, and which minimize project completion time and cost.

Therefore, what is needed is a scheduling system that optimizes scheduling and allocation of tasks for multiple members of a project team and which minimizes the project time and cost given a set of tasks and a set of people (or resources) who make up the project team to collectively perform those tasks and given a set of constraints on the tasks such as minimum resource requirements, execution time, mutual dependencies, urgency, importance, etc.; and which considers the preferences of individual team members for tasks, the per-person and total resource cost, and other constraints such as off-time in order to get the project to a point of completion in which all tasks are accomplished within the defined constraints.

### BRIEF DESCRIPTION

Some embodiments of the invention include a novel method for collectively optimizing group schedules to minimize project completion time and project cost. The method of some embodiments uses optimization techniques to collectively minimize the time and cost for the whole project, given the tasks, members and their attributes and dependencies.

Some embodiments include a novel system that collectively optimizes group schedules in a manner that minimizes project completion time and project cost. In some embodiments, the system includes a project and task data store, a data validation engine, an analytics and correlation engine to resolve task prerequisites and dependencies, an optimizer to identify optimal task schedules according to a set of team members and associated project attributes, and an output generator to format a project calendar with all tasks and member assignments.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a method for collectively optimizing group schedules to minimize project completion time and project cost in some embodiments.

FIG. 2 is a continuation of the method of FIG. 1.

FIG. 3 is a continuation of the method of FIG. 2.

FIG. 4 conceptually illustrates a schematic view of a system that collectively optimizes group schedules to minimize project completion time and cost in some embodiments.

FIG. 5 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments include a method for collectively optimizing group schedules to minimize project completion time and project cost. The method of some embodiments uses optimization techniques to collectively minimize the time and cost for the whole project, given the tasks, members and their attributes and dependencies.

Some embodiments include a novel system that collectively optimizes group schedules in a manner that minimizes project completion time and project cost. In some embodiments, the system includes a project and task data store, a data validation engine, an analytics and correlation engine to resolve task prerequisites and dependencies, an optimizer to identify optimal task schedules according to a set of team members and associated project attributes, and an output generator to format a project calendar with all tasks and member assignments.

As stated above, available project management and calendaring tools are not capable of efficiently allocating a set of project tasks to a set of team members and optimizing the schedules of those team members across the entire team in a way that provides for the best possible task allocation for the group members, and which minimize project completion time and cost.

Embodiments of the invention described in this specification solve the inefficiencies and inabilities of the existing project management and calendaring tools using a method for collectively optimizing group schedules to minimize completion time and project cost. The method of some embodiments uses optimization techniques to collectively minimize the time and cost for the whole project, given the tasks, members and their attributes and dependencies. In some embodiments, the method is implemented as a software application comprising a set of algorithms that read all the tasks and team member information, consider end-to-end scheduling and optimize the assignment of tasks to the members in a way that maximizes parallelism with other members, resolves task dependencies, attempts to assign tasks to favorable members, and minimizes time and cost collectively. The output is a group-calendar or project description that describes the optimal allocation for the entire group.

The embodiments described in this specification differ from and improve upon currently existing options. In particular, some embodiments differ by accounting for a set of attributes (i.e., more than 24 in some embodiments) of tasks and their potential members, and optimizes the group allocation. Existing software tools require the project manager to define the task allocation for the group. In contrast, the software system that implements the method described in this disclosure can provide input to most existing project management tools. Furthermore, the software system of some embodiments implements method in a way that automates the allocation process itself In addition, these embodiments improve upon the currently existing options by the fast automation of tasks to team members, which overcomes the difficult problem of requiring a human project manager to manually account for all task and team member attributes and/or parameters in the existing project management tools, which, to date, have been unable to optimize time and cost. However, the optimization techniques of some embodiments of the method described in this specification are able to collectively minimize the time and cost for the whole project, given the tasks, the team members, and their attributes and dependencies.

The method of the present disclosure may be comprised of the following steps. This list of possible constituent steps is intended to be exemplary only and it is not intended that this list be used to limit the method of the present application to just these steps. Persons having ordinary skill in the art relevant to the present disclosure may understand there to be equivalent steps that may be substituted within the present disclosure without changing the essential function or operation of the method.
1. Read the desired project start and end times
2. Read all the task names in the system, along with information on if the task needs to be executed at a fixed time or if it is flexible by a certain amount or completely flexible, whether it needs to be repeated daily/weekly/monthly
3. Read each task's dependencies (prerequisites) with respect to other tasks
4. Read the typical time required to perform the task
5. Read the urgency level (Platinum/Gold/Silver/Bronze) and the Importance level (Platinum/Gold/Silver/Bronze) for each task.
6. Read specification of which tasks can be contemporaneously multi-tasked by anyone
7. Read information on which members are favored for doing certain tasks, and which members are not favored for allocating that task.
8. Read the information on all the resources (members) and their usual time zones, work times, and availability days/times through the project time.
9. Read all the members email address, contact info, and a list for their favored co-workers and unfavored co-workers.
10. Read every member's hourly or flat-rate fees.
11. Resolve task dependencies using graph theory algorithms like topology sort, and adjust the urgency and importance of prerequisite tasks to avoid priority inversion.
12. Priority may be defined as a vector of parameters (i.e., Urgency, Importance, etc.). Perform vector-level scheduling of the tasks according to, for example, the Urgency Importance parameters.
13. Allocate members, sorted according to their increasing cost, to tasks based on their availability and preferred status, and allocate other users from the general pool after giving preference to the preferred members.
14. Generate formatted calendar output (e.g., iCalendar or other calendar formats) containing optimized task allocation to members in the team.

The various steps of the method of the present disclosure may be related in the following exemplary fashion. It is not intended to limit the scope or nature of the relationships between the various steps and the following examples are presented as illustrative examples only. Steps (1) through (10) describe 24 different attributes of tasks and members collectively. Steps 11 onwards define the workflow to optimize them together.

To make the method of the present disclosure, a person would start with a project that has multiple tasks and members, and from that point, would identify a set of tasks and members. First, the person may need to define all the task/member/global attributes. The tasks, member attributes and parameters, and global attributes and parameters may include the following exemplary set of attributes and parameters. This list of possible tasks, member attributes and parameters, and global attributes and parameters is intended to be exemplary only and it is not intended that this list be used to limit the method of the present application to just these tasks, attributes and/or parameters. Persons having ordinary skill in the art relevant to the present disclosure may understand there to be equivalent tasks, attributes, and/or parameters that may be substituted within the present disclosure without changing the essential function or operation of the method. Specially, the tasks, attributes, and parameters may include: schedule time zone ID, schedule start date and time, schedule end date and time, routine weekly days off for members, routine daily work start time, routine daily work end time, task name, urgency level, importance level, estimated duration of task, desired number of people together required to do the task, prerequisite tasks (i.e., #1 prerequisite task, . . . , #N prerequisite task), optional fixed start time, expected time of assignment (ETA), any acceptable plus-or-minus tolerance in case of fixed ETA above, recurrence of ETA tasks (in some embodiments, can only be specified for fixed ETA tasks), recurrence date range, favored members for this task (i.e., #1 favored members for this task, . . . , #N favored members for the task), un-favored members for this task (i.e., #1 un-favored members for this task, . . . , #N un-favored members for the task), cross-member task performance (i.e., “multi-taskable” task, or rather, can a member “multitask” other tasks in parallel with this task?), member name, email address, cell phone number, work phone number, usual work hours (i.e., work start time and work end time), usual workdays, hourly fee, PTO/VTO #1-#N dates (e.g., member vacation time, member sick leave time, etc.), preferred co-worker (i.e., #1-#N preferred co-workers), etc. Note that the list of favored members is separate from the list of un-favored members. These lists are mutually exclusive, meaning that when a particular member lists another member in the favored list, that other member will not be listed in the un-favored list for the particular member (and likewise).

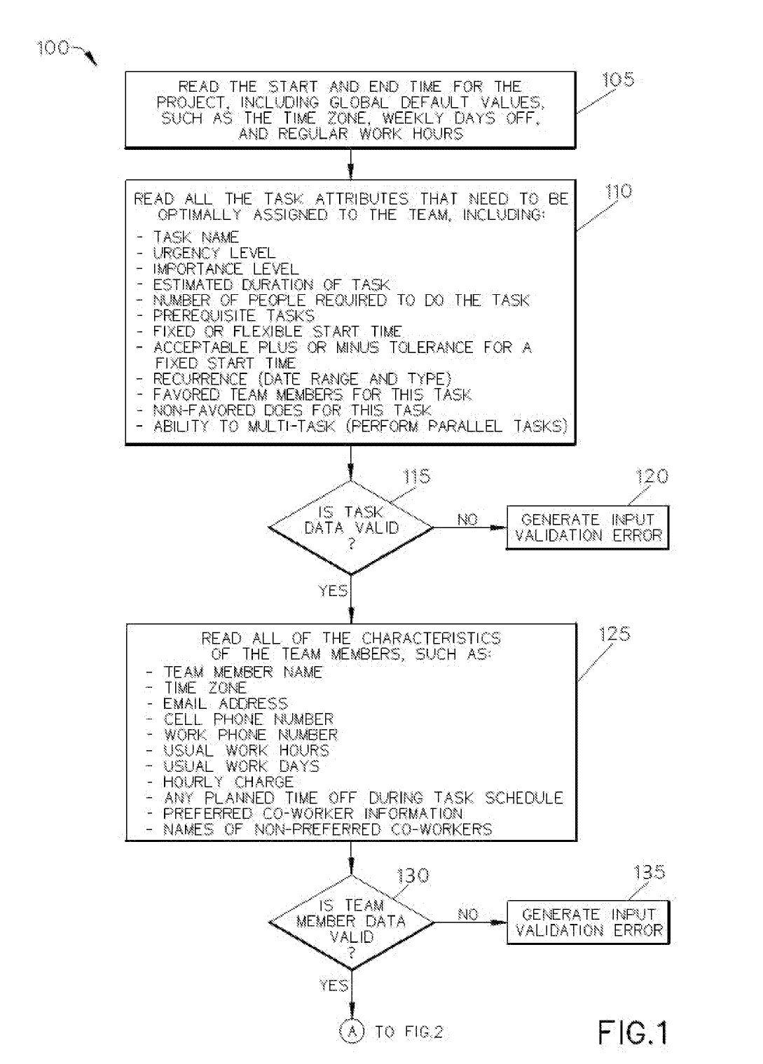

By way of example, FIGS. 1-3 conceptually illustrate a method for collectively optimizing group schedules to minimize project completion time and cost. As shown in FIG. 1, the method begins by reading (at 105) the start and end times for the project. This includes global default values, such as the time zone in which the project is to be performed or completed, weekly days off, and regular work hours of the project work place(s). Next, the method reads (at 110) all the task attributes that need to be optimally assigned to the team. Task attributes may vary from project to project, but can include any of the following: task name, urgency level, importance level, estimated time during to complete task, the number of people to complete the task, one or more prerequisites (i.e., other tasks which may need to be completed, or started, prior to the present task), a determination of whether the task has a fixed or flexible start time (and if the task has a fixed start time, a threshold level of tolerance to vary the start time before or after the fixed time), recurrence (if any) including data range and type, favored team members for the task, non-favored team members for the task, and the ability to multi-task by team member assigned to task (i.e., perform parallel tasks).

After reading in the task attributes, the method 100 determines (at 115) whether the data is valid. If the task data is determined not to be valid, the method generates (at 120) an error indicating that the task data was not validated. In this way, a user can go back and correct any of the incorrect task-related data.

On the other hand, if the method determines that the task data is valid, then the method reads in (at 125) all of the characteristics of the team members. Such characteristics include, without limitation, member name, time zone, email address, telephone numbers (cell and work), usual work hours and days, hourly charge or rate, any existing or anticipated planned days off when task pending, preferred co-worker details, and names of non-preferred co-workers.

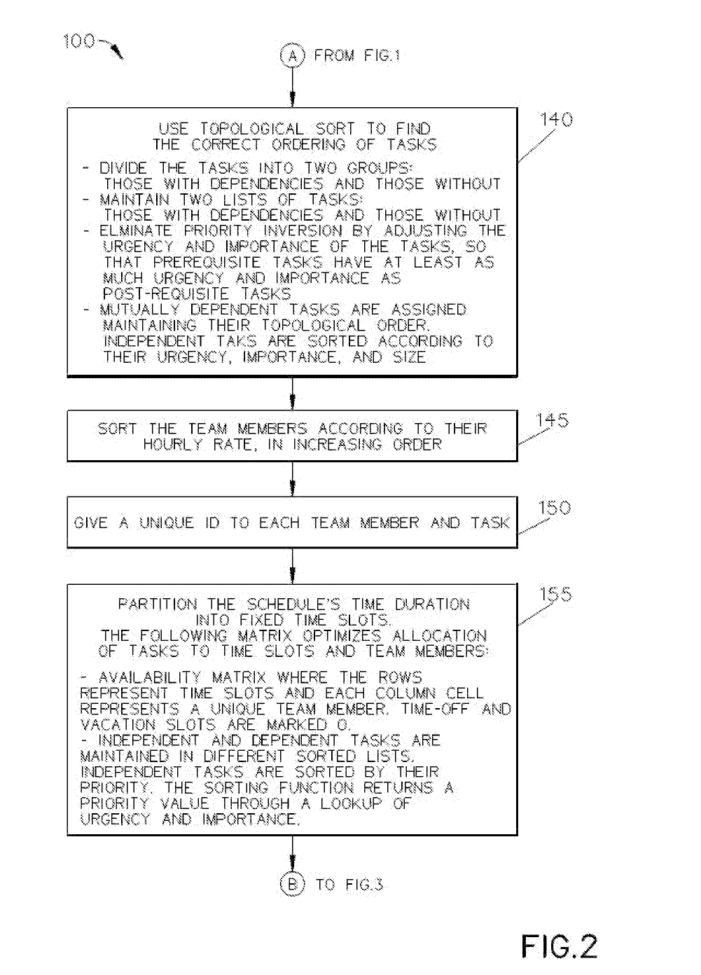

Next, the method 100 determines (at 130) whether the team member data is valid. If invalid data was input, the method generates (at 135) a validation error to allow for correction. When the team member data is valid, the method 100 transitions to 140 (top of FIG. 2).

As shown in FIG. 2 (which includes steps in continuation of the method 100), the method 100 uses a topological sort (at 140) to find a correct ordering of tasks. In doing so, the method 100 may perform one or more of the following optimization functions. These functions include dividing the tasks into multiple groups. For example, the method may divide the tasks into two groups: a first group for tasks with dependencies and a second group for tasks with no dependencies. Another function the method may perform is maintaining multiple lists of tasks (e.g., one list for the tasks in the first group and another list for the tasks in the second group). Then the method may eliminate priority inversion. The method does this by adjusting urgency and importance of tasks so that prerequisite tasks have at least as much urgency and importance as post-requisite tasks. The method also assigns mutually dependent tasks (if any), while maintaining the topological order of the tasks. Independent tasks, on the other hand, are sorted by the method based on urgency, importance, and/or size or scope.

The method 100 then sorts (at 145) the team members by some metric, such as hourly rate. The sort may be in any order a user prefers, for instance, alphabetical by name, or increasing hourly rate order, etc. The method next gives (at 150) a unique ID to each team member and task. Once these are completed, the method 100 moves on to partition (at 155) the schedule's time duration into fixed time slots, such that a task allocation matrix optimizes the tasks for the available time slots and team members. For example, the matrix may have rows for the available time slots and columns for the team members. Also, independent and dependent tasks may be maintained in separate sorted lists.

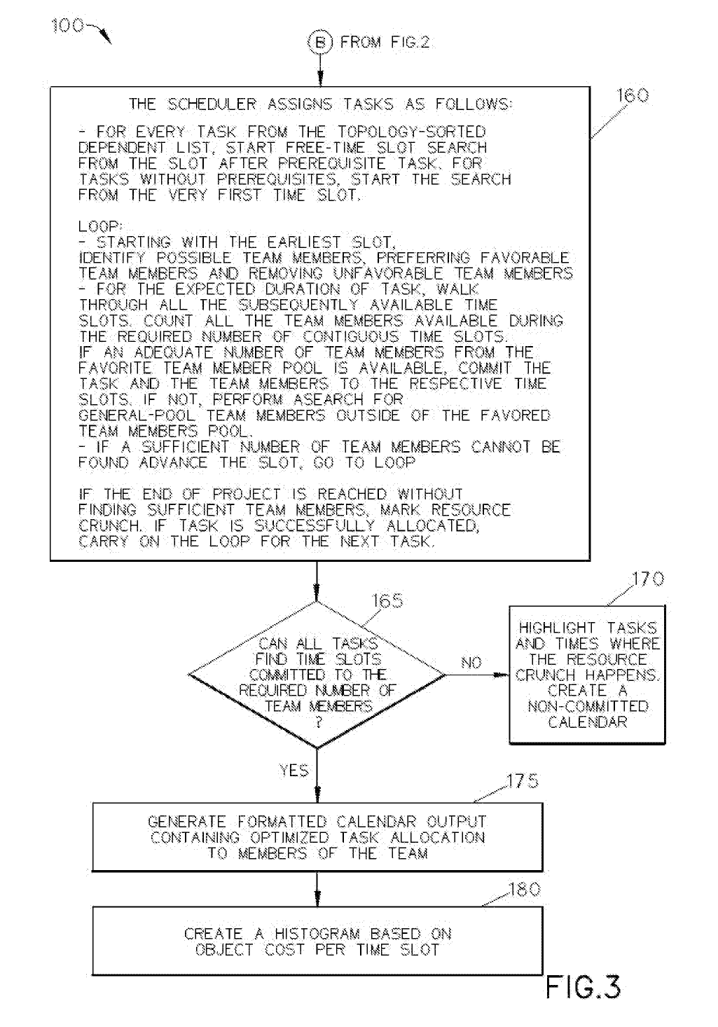

As shown in FIG. 3 (which further includes steps in continuation of the method 100), the method 100 performs a set of scheduler operations (at 160) to assign the tasks. The assignment of tasks includes at least one operation of looking for a free time slot for each task in the topological-sorted dependent list, starting with time slots that occur after a prerequisite task (if any). Then the method performs a set of operations in a loop, starting with the earliest available time slot. These looped operations include identifying possible team members and setting preferences and non-preferred members. The method also determines the time slots needed for the expected duration of the task, in consideration of the members that may be assigned to the task. If a requisite number of team members are found and assigned, the method breaks out of the loop. But if not, then the method returns to loop through the operations again.

Next, the method determines (at 165) whether time slots can be found for all tasks according to the number of team members needed. If not, the method highlights (at 170) the tasks and times in which a resource crunch occurs, and thereafter creates a non-committed calendar. On the other hand, if the method can allocate time slots for all tasks, then the method generates (at 175) a calendar with formatted calendar output with an optimized allocation of tasks to members of the team. Then the method 100 creates (at 180) a histogram based on the object cost per time slot.

The method generally works in a way that the project calendar is treated as a table of members as columns and calendar time slots as rows. The tasks are allocated to members and blocked off in the calendar depending on their priority (urgency and importance), multitaskability, expected time and other attributes defined earlier. The members are picked such that favored people to do the task are preferred first, followed by resources from the general pool. Unfavored members to perform a given task are avoided. If no resources are available, resource crunch is flagged. This is a greedy algorithm to fit in urgent and important tasks first but also opportunistically fit in important tasks that are not urgent, before they become urgent. It may use techniques such as bin-packing or optionally, simulated annealing.

Also, tasks that have dependencies need to be resolved and the prerequisite task priority and preference needs to be automatically adjusted. If the members have preferred tasks, they are given preferential allocation. If the members are not preferred for a task, they are not allocated. The members are allocated such as to minimize the cost of the project and the time together.

After defining the set of tasks, member attributes and parameters, and global attributes and parameters, the person may then apply the algorithm steps to optimize the task allocation to the members to minimize the cost and collective time. In some embodiments, all the steps that form input to the optimizer are necessary, with default values if not specified by the user. Inputs can be rearranged, but the optimizer will consider them in specified order to be optimized.

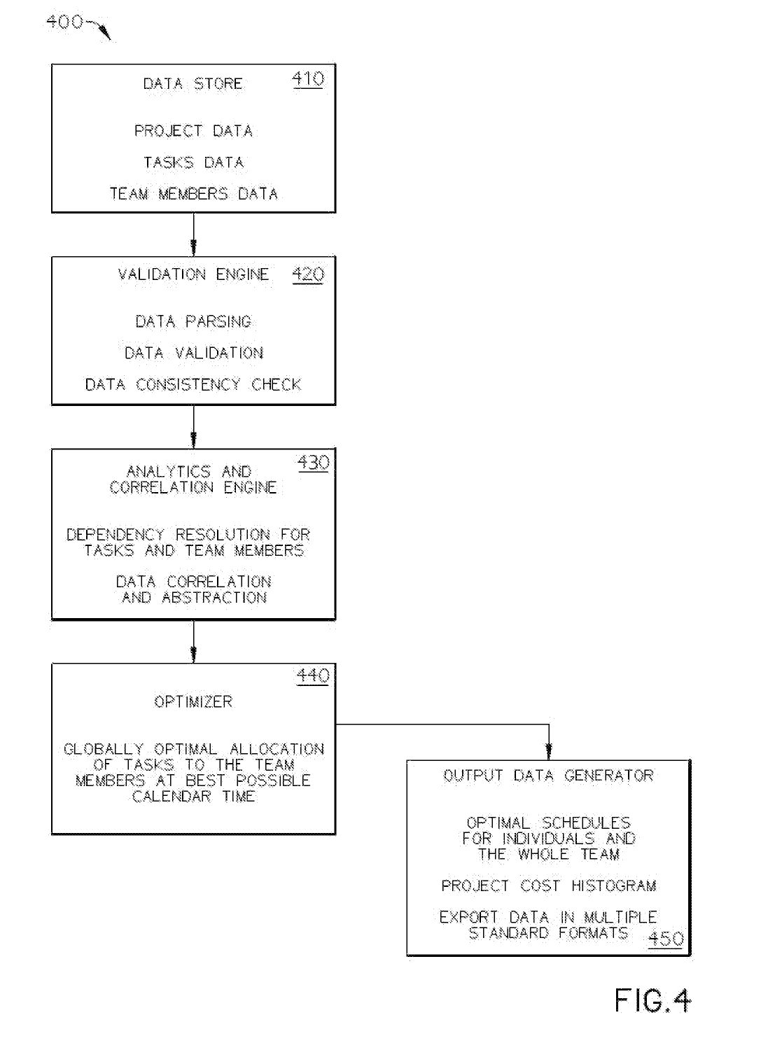

By way of example, FIG. 4 conceptually illustrates a schematic view of a calendaring system 400 that collectively optimizes group schedules to minimize project completion time and cost. As shown in this figure, the calendaring system 400 includes a set of modules and components. In some embodiments, the set of modules and components implement the method. For example, the set of modules and components can include a set of software systems that operate in conjunction with each other on a set of computing devices in order to collectively optimize group schedules for one or more projects involving a set of tasks to be started and completed in a specified calendar date time frame by a set of project team members. In some embodiments, the set of modules and components of the calendaring system 400 includes a data store 410 which stores data for the projects, tasks, and team members, a validation engine 420 to ensure data validity, an analytics and correlation engine 430 to resolve dependencies and perform data correlation, an optimizer 440 to optimally allocate all tasks of a project among the team members over a calendar time related to the expected duration of the project, and an output data generator 450, which outputs an optimized calendar of tasks and a cost histogram, as well as providing functions for exporting data in any of several formats.

To use the system 400, a person (i.e., a team member or project manager) would use a software application or a package of software applications and programs that work in conjunction with each other to perform the operations and provide the features and benefits of the method 100. In some embodiments, the software package may be available to use over the Internet. For example, the software package may run as a service hosted by a web server application that includes a service oriented architecture (SOA) which supports multiple simultaneous client connects from members and project managers. Typically a project manager or event manager will input all the data using web or other user interface. The output may be generated as a computer file in a calendar format (e.g., such as iCalendar) that can be directly read into other project management tools.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. For example, while the method solves a constraint-based optimization problem, the method can be adapted for use in allocating computer-related or robotic resources to do a set of jobs.

Also, many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

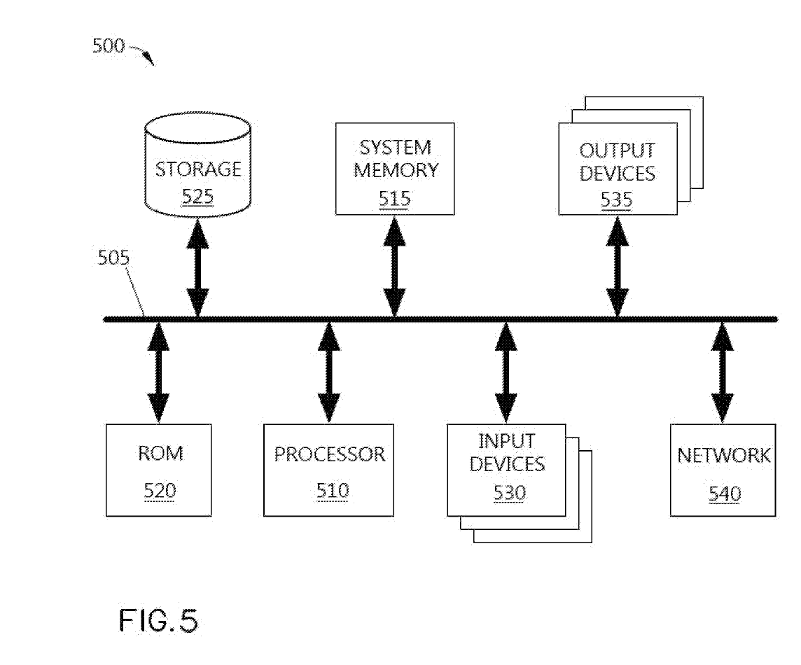

FIG. 5 conceptually illustrates an electronic system 500 with which some embodiments of the invention are implemented. The electronic system 500 may be a computer, phone, PDA, or any other sort of electronic device. Such an electronic system includes various types of computer readable media and interfaces for various other types of computer readable media. Electronic system 500 includes a bus 505, processing unit(s) 510, a system memory 515, a read-only 520, a permanent storage device 525, input devices 530, output devices 535, and a network 540.

The bus 505 collectively represents all system, peripheral, and chipset buses that communicatively connect the numerous internal devices of the electronic system 500. For instance, the bus 505 communicatively connects the processing unit(s) 510 with the read-only 520, the system memory 515, and the permanent storage device 525.

From these various memory units, the processing unit(s) 510 retrieves instructions to execute and data to process in order to execute the processes of the invention. The processing unit(s) may be a single processor or a multi-core processor in different embodiments.

The read-only-memory (ROM) 520 stores static data and instructions that are needed by the processing unit(s) 510 and other modules of the electronic system. The permanent storage device 525, on the other hand, is a read-and-write memory device. This device is a non-volatile memory unit that stores instructions and data even when the electronic system 500 is off. Some embodiments of the invention use a mass-storage device (such as a magnetic or optical disk and its corresponding disk drive) as the permanent storage device 525.

Other embodiments use a removable storage device (such as a floppy disk or a flash drive) as the permanent storage device 525. Like the permanent storage device 525, the system memory 515 is a read-and-write memory device. However, unlike storage device 525, the system memory 515 is a volatile read-and-write memory, such as a random access memory. The system memory 515 stores some of the instructions and data that the processor needs at runtime. In some embodiments, the invention's processes are stored in the system memory 515, the permanent storage device 525, and/or the read-only 520. For example, the various memory units include instructions for processing appearance alterations of displayable characters in accordance with some embodiments. From these various memory units, the processing unit(s) 510 retrieves instructions to execute and data to process in order to execute the processes of some embodiments.

The bus 505 also connects to the input and output devices 530 and 535. The input devices enable the user to communicate information and select commands to the electronic system. The input devices 530 include alphanumeric keyboards and pointing devices (also called “cursor control devices”). The output devices 535 display images generated by the electronic system 500. The output devices 535 include printers and display devices, such as cathode ray tubes (CRT) or liquid crystal displays (LCD). Some embodiments include devices such as a touchscreen that functions as both input and output devices.

Finally, as shown in FIG. 5, bus 505 also couples electronic system 500 to a network 540 through a network adapter (not shown). In this manner, the computer can be a part of a network of computers (such as a local area network (“LAN”), a wide area network (“WAN”), or an intranet), or a network of networks (such as the Internet). Any or all components of electronic system 500 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIGS. 1-3 conceptually illustrate a process. The specific operations of the process may not be performed in the exact order shown and described. Specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

I claim:

1. A non-transitory computer readable medium storing a program which, when executed by at least one processing unit of a computing device, collectively optimizes group schedules for a group of team members collectively working on a project in order to minimize project completion time and project cost, said program comprising sets of instructions for:
receiving a set of project start and end times;
receiving a set of task names and a set of task parameters comprising a time flexibility parameter and a frequency parameter;
automatically retrieving dependencies associated with each task in the set of tasks;
automatically retrieving, for each task, a priority vector comprising an urgency level and an importance level;
automatically determining which tasks in the set of tasks can be multi-tasked;
automatically retrieving a set of member attributes for each team member, said member attributes comprising a task favorability attribute for each task, a set of working hours, a set of contact details, and a set of member rate information;
resolving a set of task dependencies using one or more graph theory algorithms;
performing vector-level scheduling of the tasks according to the priority vector in relation to each member;
allocating members to the tasks; and
generating a formatted group calendar for the project, said group calendar comprising optimized task allocation to the members of the team.

2. The non-transitory computer readable medium of claim 1, wherein the set of project start and end times comprises an expected calendar start date and an expected calendar end date.

3. The non-transitory computer readable medium of claim 1, wherein the program further comprises a set of instructions for dividing the set of tasks into a plurality of task sets comprising a first set of tasks with one or more dependencies and a second set of independent tasks.

4. The non-transitory computer readable medium of claim 3, wherein the set of instructions for automatically retrieving dependencies associated with each task comprises a set of instructions for retrieving the dependencies of tasks in the first set of tasks.

5. The non-transitory computer readable medium of claim 1, wherein the set of instructions for performing vector-level scheduling of the tasks comprises a set of instructions for identifying any prerequisite tasks and starting at a time slot after the identified prerequisite tasks.

6. A system that collectively optimizes group schedules for a group of team members collectively working on a project in order to minimize project completion time and project cost, said system comprising:
a data store that stores project data for at least one project, task data for a set of tasks related to the project, and team member data for each member of a team who is assigned to work on and complete a task related to the project;
a validation engine to check data input for the project, the set of tasks related to the project, and the team members assigned to work on and complete tasks of the project;
an analytics and correlation engine to resolve dependencies between tasks of the project and perform data correlation for time scheduling, expected durations, and assigned team members associated with each task;
an optimizer module to optimally allocate all tasks of a project among the team members over a calendar time related to the expected duration of the project; and
an output generator that outputs an optimized calendar of tasks related to the project over the expected duration of the project.

7. The system of claim 6, wherein the output generator further outputs a cost histogram that details object cost of the project based on an hourly rate of each team member assigned to complete a task of the project.

8. The system of claim 6, wherein the output generator further exports calendar data in a format that can be used as input to a different calendar system.

9. The system of claim 6, wherein the optimizer module identifies optimal working groups of team members for tasks that require more than one team member to complete.

10. The system of claim 9, wherein the optimizer module reviews a set of preferred team members and a set of non-preferred team members provided by each team member of the project, and assorts the optimal working groups based on such member-specified preferences.

11. The system of claim 6 further comprising a post-optimization data analytics engine that analyzes a set of historical projects to identify at least one specific metric which was satisfied a threshold percentage of time in a set of successful projects within the set of historical projects.

12. The system of claim 11 further comprising a correlation engine that correlates any specific metric that is common for one of all successful historical projects and all unsuccessful historical projects.
